(19) United States
(12) Patent Application Publication
(10) Pub. No.: US 2007/0174418 A1
(43) Pub. Date: Jul. 26, 2007

(54) Display firmware upgrade without external devices

(75) Inventors: Juventino Garcia JR., Pflugerville, TX (US); Seen Yee Cindy Cheong, Singapore (SG); Yoko Simon, Round Rock, TX (US); Joe E. Goodart, Austin, TX (US); Vinesh Gandhi, Singapore (SG); Shuguang Wu, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/337,362

(22) Filed: Jan. 23, 2006

(51) Int. Cl. G06F 15/16

(52) U.S. Cl. 709/217

(57) ABSTRACT

In a system for upgrading firmware of a display device (DD), a plurality of instructions are executable by a processor to upgrade the firmware. A graphics controller, which is coupled to the processor, generates the displays displayable on the DD. The DD is coupled to the graphics controller via a cable and the communications between them is compliant with a display data channel command interface (DDC/CI) standard defined by video electronics standard association (VESA). The plurality of instructions are communicated to a DD controller of the DD via the cable. The DD controller decodes the plurality of instructions received into a set of commands specific to the DD and the DD controller writes the set of commands to the firmware to upgrade.

### BACKGROUND

The present disclosure relates generally to the field of display systems, and more particularly to tools and techniques for improving performance, reliability and user experience of display devices included in information handling systems.

As the value and use of information continues to increase, individuals and businesses seek additional ways to acquire, process and store information. One option available to users is information handling systems. An information handling system (‘IHS’) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, entertainment, and/or global communications. In addition, information handling systems may include a variety of hardware and software components that may be configured to process, store, and communicate information and may include one or more computer systems, data storage systems, and networking systems.

Display devices such as a cathode ray tube (CRT), a liquid crystal display (LCD), a plasma display, and a projection display system, which are included in an IHS enable the user of an application to view the results of the actions taken and/or in response to inputs provided to the IHS. The purpose of a display device is to present to the user an image supplied by the IHS system. Display devices typically include a plurality of user controls, which may vary depending upon the manufacturer and display technology. Typical display controls available to the user include setting luminance, contrast, picture size, position, and color balance. In addition, displays frequently have a number of internal settings that are changed to optimize operation with different video display formats, such as 4:3 and 16:9 aspect ratios. Some display devices may include other optional features, e.g. audio, which may also be controlled by the user.

FIG. 1 is a block diagram illustrating an external adapter based legacy system for upgrading display device firmware, according to prior art. A host computer 110 is coupled to a display device 120 via an external adapter 130 (also referred to as a dongle) for upgrading a firmware 122 included in the display device (DD) 120. The firmware 122 is typically a non-volatile memory such as an EPROM, EEPROM or FLASH memory. A parallel port 112 of the host computer is coupled to a similar parallel port 132 of the external adapter 130. The external adapter 130 transfers signals from the parallel port 132 to an analog cable connector 134. The external adapter 130 is coupled to the DD 120 via a standard VGA analog cable 140, e.g., DB15 and/or DVI. An analog cable connector 124 included in the DD 120 is coupled to the firmware 122. Upgrading the firmware 122 includes downloading new information to the firmware 122. To perform a firmware upgrade, a software utility 150 is executed in the host computer 110 and generates new instructions to be downloaded to the firmware 122 via the parallel port 132, the analog cable connector 134, the analog cable 140 and the analog cable connector 124. The host computer 110 includes a graphics card 160. However, the graphics card 160 is not used to upgrade the firmware 122 of the DD 120.

Thus, present solutions for upgrading the firmware 122 primarily rely on use of external adapters that may vary with each display device supplier. That is, many display device suppliers typically provide a proprietary version of the external adapter and/or dongle along with a unique set of installation procedure for upgrading the firmware 122. Users typically send the DD 120 to a manufacturer of the IHS or a manufacturer of the display device for the upgrade. As an alternate, the manufacturer may elect to perform an on-site upgrade. This increases product/warranty costs to the manufacturer, reduces reliability of the IHS and negatively affects user experience.

Therefore, a need exists to provide an improved method and system for upgrading firmware of display devices. Accordingly, it would be desirable to provide a method and system for upgrading firmware of display devices included in an information handling system, absent the disadvantages found in the prior methods discussed above.

### SUMMARY

The foregoing need is addressed by the teachings of the present disclosure, which relates to a system and method for upgrading firmware of display devices.

In one aspect of the disclosure, a method for upgrading firmware of a display device (DD) includes receiving a plurality of instructions to upgrade the firmware. The plurality of instructions are provided by a host device directly coupled to the DD via a cable. The plurality of instructions are decoded into a set of commands that are specific to the DD. The set of commands are stored in the firmware to complete the upgrade.

Several advantages are achieved by the method and system according to the illustrative embodiments presented herein. The embodiments advantageously provide for an improved automated technique to upgrade firmware of a display device (DD) by eliminating the use of external adapters and/or dongles. The firmware upgrade utility software, which is downloadable via the Internet or distributed via optical media, enables the user to upgrade the firmware of the DD without having to send the DD to the manufacturer or without needing manufacturers on-site firmware upgrade services. Thus, the improved technique for upgrading firmware advantageously reduces costs, improves performance and reliability of the DD, and enhances user experience.

### BRIEF DESCRIPTION OF THE DRAWINGS

FIG. 1 is a block diagram illustrating an external adapter based legacy system for upgrading display device firmware, described hereinabove, according to prior art.

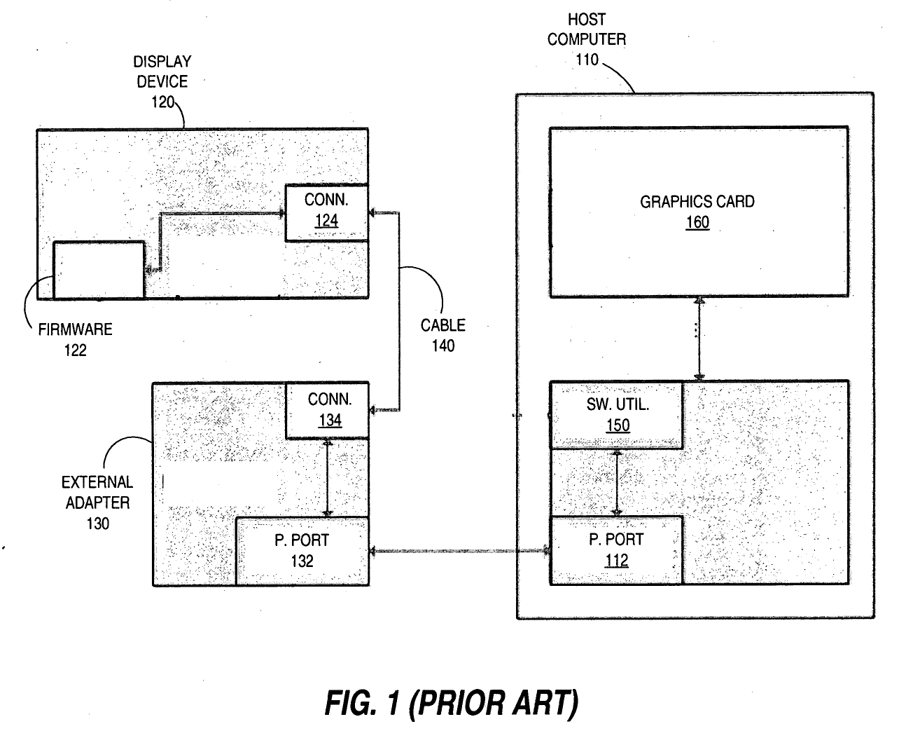

FIG. 2 illustrates a block diagram of an information handling system having an upgradeable display firmware, according to an embodiment.

FIG. 3 is a block diagram illustrating further details of the display device (DD) having an upgradeable firmware described with reference to FIG. 2, according to an embodiment.

FIG. 4 is a flow chart illustrating a method for upgrading firmware of a display device (DD), according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/ or components described herein may be implemented as hardware (including discrete components, integrated circuits and systems-on-a-chip ‘SOC’), firmware (including application specific integrated circuits and programmable chips) and/or software or a combination thereof, depending on the application requirements.

Firmware of a display device (DD) may need to be upgraded for a variety of reasons such as bug fixes, change in functionality of the DD, desired improvement in performance, and similar others. Present techniques for upgrading the firmware of the DD typically use proprietary external adapters, thereby making it difficult for the user to implement the upgrade. As a result, the user typically sends the DD to the manufacturer for the upgrade. If a large number of display devices are to be upgraded, the manufacturer may perform an on-site upgrade. It is desirable that the DD firmware upgrade process be simple, use standards based interfaces, and be user implementable. Presently, no tools and/or techniques exist to enable the user to automatically perform the firmware upgrade of the DD. Thus, a need exists to provide improved tools and techniques to a user for implementing a firmware upgrade of the DD.

According to one embodiment, in a method and system for upgrading firmware of a display device (DD), a plurality of instructions are executable by a processor to upgrade the firmware. A graphics controller, which is coupled to the processor, generates the displays displayable on the DD. The DD is coupled to the graphics controller via a cable and the communications between them is compliant with a display data channel command interface (DDC/CI) standard defined by video electronics standard association (VESA). The plurality of instructions are communicated to a DD controller of the DD via the cable. The DD controller decodes the plurality of instructions received into a set of commands specific to the DD and the DD controller writes the set of commands to the firmware to upgrade.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, or any other suitable device and may vary in size, shape, performance, functionality, and price. The information handling system may include random access memory (RAM), one or more processing resources such as central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to receive/transmit communications between the various hardware components.

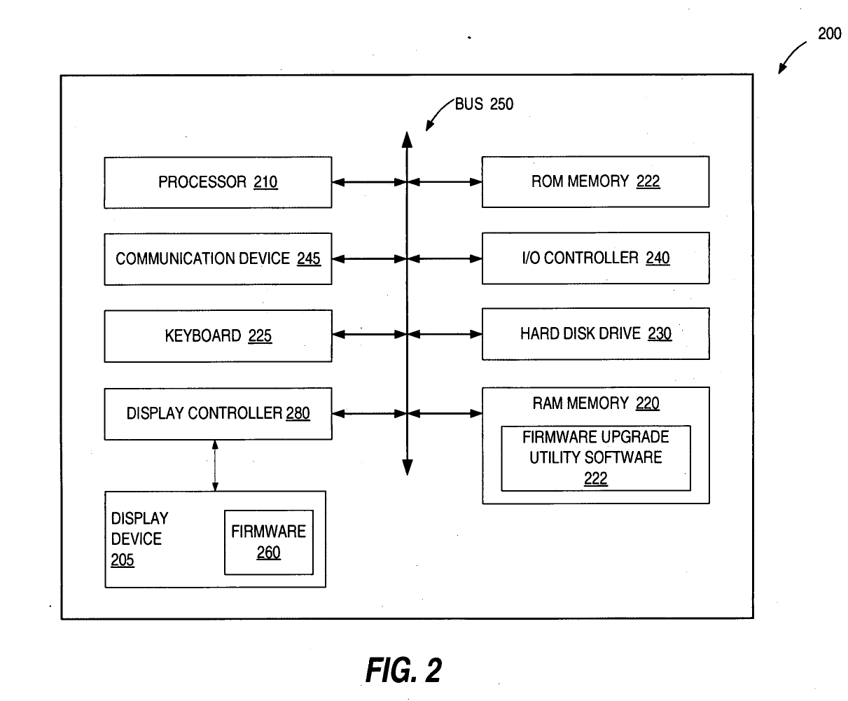

FIG. 2 illustrates a block diagram of an information handling system 200 having an upgradeable display firmware 260, according to an embodiment. The information handling system 200 includes a processor 210, a system random access memory (RAM) 220 (also referred to as main memory), a non-volatile ROM 222 memory, a graphics controller 280 coupled to a display device (DD) 205 having the upgradeable firmware 260, a keyboard 225 and an I/O controller 240 for controlling various other input/output devices. For example, the I/O controller 240 may include a keyboard controller, a cursor device controller and/or the serial I/O controller. It should be understood that the term “information handling system” is intended to encompass any device having a processor that executes instructions from a memory medium.

In a particular embodiment, the DD 205 is one of a cathode ray tube (CRT) display, a liquid crystal display (LCD), a plasma display, a projector display, a television (TV) and a high definition television (HDTV).

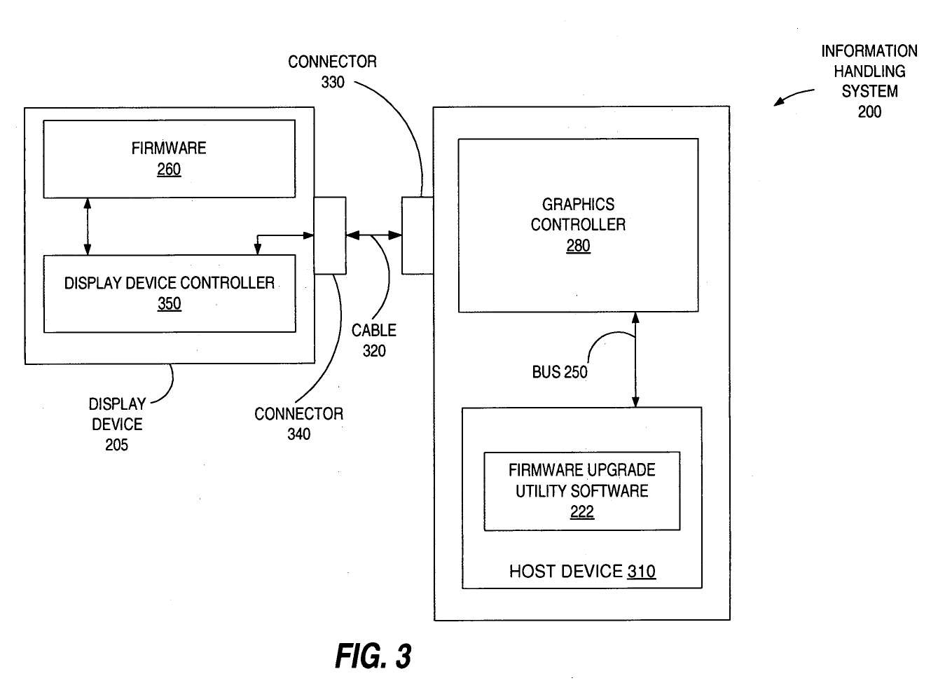

The processor 210 communicates with the system components via a bus 250, which includes data, address and control lines. In one embodiment, the IHS 200 may include multiple instances of the bus 250. A communications device 245, such as a network interface card and/or a radio device, may be connected to the bus 250 to enable wired and/or wireless information exchange between the IHS 200 and other devices or networks such as the Internet (not shown). In an embodiment, the upgradeable firmware 260 is implemented as a FLASH memory. Additional detail of the DD 205 having the upgradeable firmware 260 is described with reference to FIG. 3.

The processor 210 is operable to execute the computing instructions and/or operations of the IHS 200. The memory medium, e.g., RAM 220, preferably stores instructions (also known as a “software program”) for implementing various embodiments of a method in accordance with the present disclosure. An operating system (OS) of the IHS 200 is a type of software program that controls execution of other software programs, referred to as application software programs.

In the depicted embodiment, the RAM 220 stores a firmware upgrade utility software 222 for implementing the firmware upgrade. In a particular embodiment, the firmware upgrade utility software 222 may be distributed on an optical media such as a CD-ROM and loaded from the optical media into the RAM 220. In an embodiment, the firmware upgrade utility software 222 may be distributed electronically via the Internet and received by the IHS 200 via the communications device 245. A user executes the firmware upgrade utility software 222 to load the program in the RAM 220 to automatically perform the upgrade. In various embodiments the instructions and/or software programs such as the firmware upgrade utility software 222 may be implemented in various ways, including procedure-based techniques, component-based techniques, and/or object-oriented techniques, among others. Specific examples include assembler, C, XML, C++ objects, Java and Microsoft's .NET technology.

Additionally, it is important to note that while the present disclosure has been described in the context of an IHS having hardware and software, those of ordinary skill in the art will appreciate that the processes of the present disclosure are capable of being distributed as computer readable medium of instructions in a variety of forms and that the present disclosure applies equally regardless of the particular type of signal bearing media actually used to carry out the distribution. Examples of computer readable media include recordable-type media such a floppy disc, a hard disk drive, a RAM, optical media such as CD-ROM's, DVD's and transmission-type media such as digital and analog communications links.

FIG. 3 is a block diagram illustrating further details of the display device (DD) 205 having the upgradeable firmware 260 described with reference to FIG. 2, according to an embodiment. In the depicted embodiment, a host device 310 is coupled to the graphics controller 280 via the bus 250. In a particular embodiment, the host device 310 may include one or more components of the IHS 200 such as the processor 210 coupled to the memory 220. The host device 310 is operable to execute the firmware upgrade utility software 222. Execution of the firmware upgrade utility software 222 generates a plurality of instructions to upgrade the firmware 260. In an embodiment, the firmware upgrade is performed by a user by executing the firmware upgrade utility software 222.

In the depicted embodiment, the graphics controller 280 is directly coupled to the DD 205 via a cable 320. In a particular embodiment, the cable 320 is a standard analog cable having a pair of connectors 330 and 340 located at either end to facilitate the electrical coupling. In an embodiment, the cable 320 is one of a video graphics array (VGA) cable and a digital visual interface (DVI) cable, and the connectors 330 and 340 are one of a DB15 connector and a DVI connector.

In the depicted embodiment, the DD 205 is compliant with a display device industry standard such as a display data channel command interface (DDC/CI) standard defined by video electronics standard association (VESA). The DDI/CI standard uses the I2C bus protocol for communication. That is, the cable 320 supports bidirectional communications that is in compliance with the two wire I2C bus protocol. In addition, the plurality of instructions generated by the execution of the firmware upgrade utility software 222 are in compliance with a monitor instruction standard such as a monitor control command set (MCCS) standard defined by VESA. The MCCS standard defines standardized instructions for controlling the operation of a plurality of monitors including the DD 205. The plurality of instructions may include instructions for setting luminance, contrast, picture size, position, and color balance. By having two display devices that are DDC/CI and MCCS compliant, a user may be able to interchange one display device with another with little or no change to the display control software.

In the depicted embodiment, the DD 205 includes a DD controller 350 coupled to the cable 320 via the connector 340. In an exemplary, non-depicted embodiment, the DD controller 350 includes logic circuitry to execute logic commands. That is, the DD controller 350 may include a processor for executing instructions or a field programmable gate array (FPGA) for performing logic operations. The DD controller 350 is coupled with the firmware 260.

In the depicted embodiment, the DD controller 350 receives the plurality of instructions that are in compliance with the MCCS standard from the host device 310 via the graphics controller 280 and the cable 320. The plurality of instructions are decoded by the DD controller 350 to a device specific set of commands. That is, the MCCS compliant plurality of instructions are decoded into an I2C bus compliant set of commands. The set of commands are specific to the particular display, e.g., commands are compatible with the device specific properties or attributes of the DD 205. The DD controller 350 writes the set of commands to the firmware 260 to complete the firmware upgrade.

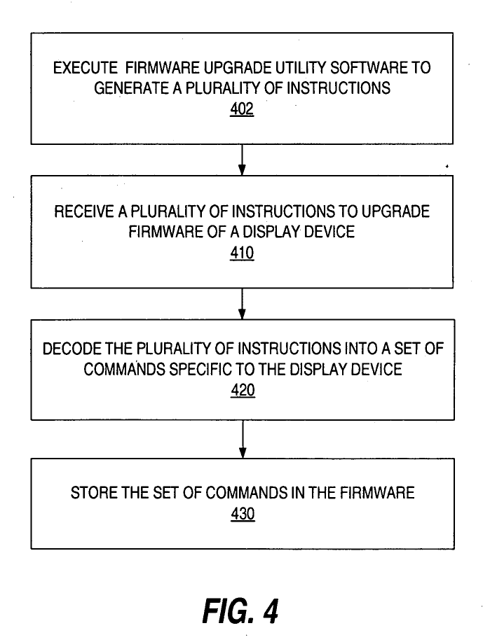

FIG. 4 is a flow chart illustrating a method for upgrading firmware of a display device (DD), according to an embodiment. In step 410, a plurality of instructions to upgrade the firmware of the DD are received. In a particular embodiment, the plurality of instructions are provided by the host device 310 and are received by the DD controller 350 described with reference to FIG. 3. In step 420, the plurality of instructions are decoded into a set of commands, which are specific to the DD, e.g., specific to the DD 205. In step 430, the set of commands are stored in the firmware, e.g., the firmware 260, to complete the firmware upgrade.

Various steps described above may be added, omitted, combined, altered, or performed in different orders. For example, an additional step may be added before the step 410 to generate the plurality of instructions. In a particular embodiment, in step 402, the firmware upgrade utility software 222 is executed to generate the plurality of instructions.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An information handling system (IHS) to upgrade firmware, the system comprising:
a processor;
a memory coupled to the processor for storing a plurality of instructions executable by the processor to upgrade the firmware;
a graphics controller coupled to the processor and the memory; and
a display device (DD) having the firmware, wherein the DD is directly coupled to the graphics controller via a cable, wherein the DD decodes the plurality of instructions to upgrade the firmware.

2. The system of claim 1, wherein the DD is compliant with a display data channel command interface (DDC/CI) standard defined by video electronics standard association (VESA).

3. The system of claim 1, wherein the DD includes a DD controller, wherein the DD controller decodes the plurality of instructions received into a set of commands specific to the DD, wherein the DD controller writes the set of commands to upgrade the firmware.

4. The system of claim 1, wherein the plurality of instructions are received electronically via a network coupled to the processor.

5. The system of claim 1, wherein the plurality of instructions are stored in the memory by executing a firmware upgrade utility software, wherein the firmware upgrade utility software is loaded into the memory from a computer readable medium.

6. The system of claim 5, wherein the firmware upgrade is performed by a user by executing the firmware upgrade utility software.

7. The system of claim 1, wherein the DD is one of a cathode ray tube (CRT) display, a liquid crystal display (LCD), a plasma display, a projector display, a television (TV) and a high definition television (HDTV).

8. The system of claim 1, wherein the plurality of instructions are in compliance with a monitor control command set (MCCS) standard defined by video electronics standard association (VESA).

9. The system of claim 1, wherein the cable is one of a video graphics array (VGA) cable and a digital visual interface (DVI) cable.

10. The system of claim 1, wherein the cable supports bidirectional communication in compliance with an I2C bus protocol.

11. A method for upgrading firmware of a display device (DD), the method comprising:
receiving a plurality of instructions to upgrade the firmware, wherein the plurality of instructions are provided by a host device directly coupled to the DD via a cable;
decoding the plurality of instructions into a set of commands, wherein the set of commands are specific to the DD; and
storing the set of commands in the firmware.

12. The method of claim 11, wherein the DD is compliant with a display data channel command interface (DDC/CI) standard defined by video electronics standard association (VESA).

13. The method of claim 11, wherein the plurality of instructions are in compliance with a monitor control command set (MCCS) standard defined by video electronics standard association (VESA).

14. The method of claim 11, wherein the cable is one of a video graphics array (VGA) cable and a digital visual interface (DVI) cable.

15. The method of claim 11, wherein the cable supports bidirectional communication in compliance with an I2C bus protocol.

16. A computer program product for use in upgrading firmware of a display device (DD), the computer program product comprising computer readable storage media including program logic embedded therein to perform:
providing a plurality of instructions to the DD directly coupled to a host device via a cable;
directing the DD to decode the plurality of instructions into a set of commands, wherein the set of commands are specific to the DD; and
storing the set of commands in the firmware.

17. The computer program product of claim 16, wherein the DD is compliant with a display data channel command interface (DDC/CI) standard defined by video electronics standard association (VESA).

18. The computer program product of claim 16, wherein the plurality of instructions are in compliance with a monitor control command set (MCCS) standard defined by video electronics standard association (VESA).

19. The computer program product of claim 16, wherein the cable is one of a video graphics array (VGA) cable and a digital visual interface (DVI) cable.

20. The computer program product of claim 16, wherein the cable supports bidirectional communication in compliance with an I2C bus protocol.
